(19) United States
(12) Patent Application Publication
(10) Pub. No.: US 2006/0238825 A1
(43) Pub. Date: Oct. 26, 2006

(54) Apparatus for and method of processing scanned image

(75) Inventors: Yu-rim Han, Suwon-si (KR); Jae-kyoo Kang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/355,141

(22) Filed: Feb. 16, 2006

(30) Foreign Application Priority Data
Apr. 23, 2005 (KR) 2005-33808

(51) Int. Cl. H04N 1/40

(52) U.S. Cl. 358/448; 358/474

(57) ABSTRACT

An apparatus for and a method of processing scanned images, that reduces data size of the scanned images by managing overlapped portions in the scanned images as a stored overlay file.

### CROSS-REFERENCE TO RELATED APPLICATION

This application claims the benefit of Korean Application No. 2005-33808, filed Apr. 23, 2005, in the Korean Intellectual Property Office, the disclosure of which is incorporated herein by reference.

### BACKGROUND OF THE INVENTION

1. Field of the Invention

An aspect of the present invention relates to an image forming apparatus in general, and, more particularly, to an apparatus for and a method of processing scanned images, cable of reducing data size of scanned images.

2. Description of the Related Art

Generally, a printer and a printing machine to perform various operations including scanning, printing, copying and facsimile transmitting operate in connection with a host device.

FIG. 1 is a diagram of a conventional network printing machine. As shown in FIG. 1, a network printing machine includes a host device 80, and a printing machine 10 connected to the host device 80 via a personal computer (PC) interface unit 30. The printing machine 10 includes a scanning unit 40, a storage unit 50, a printing unit 60, a control unit 70, an operation panel unit 20 with a display part 22 and a PC interface unit 30. The operation panel unit 20 operates as an input device to enable a user to set various operational conditions of the printing machine 10. The display part 22 displays set-conditions and a working status of the printing machine 10. The storage unit 50 stores information inputted using the operation panel unit, data (files) to be printed, scanned data, information on a user and/or a device manager, and an address including an email-address, a domain of an Internet website, and a telephone number. The control unit 70 controls the printing machine 10 to receive documents or data to be printed from the host device 80 and transmits the received data to the printing unit 60 via the PC interface unit 30 so as to be printed. The control unit further 70 controls the overall operation of the printing machine 10 to store scanned data produced by the scanning unit 40 into a hard disc drive (HDD) 86 in the host device 80 or the storage unit 50 in the printing machine 10.

The host device 80 includes a scan driver 82 to drive the scanning unit 40 of the printing machine 10 in response to an input given by a user, a printer driver 84 to drive the printing unit 60, and the HDD 86 to operate as a storage medium.

When a user sets the printing machine 10 to a scanning mode from the host device 80, the scan driver 84 in the host device 80 is driven. With the scan driver being driven, a graphic user interface (GUI) in association with the scanning operation is displayed on a screen of the host device 80 to allow a user to set scan conditions. Then, the scanning unit 40 scans a document according to the set conditions and the scanned data undergoes an image processing operation. The image processed data is stored into the storage unit 50 of the printing machine 10 or the HDD 86 of the host device 80, or printed out through the printing unit 60.

Alternatively the scanning mode may be selected using the operation panel of the printing machine 10 instead of using the host device 90. In this case, if a user selects the scanning mode using the operation panel unit of the printing machine 10, the control unit 70 displays a GUI to allow a user to set scanning conditions to the display part 22 of the operation panel unit and controls the scanning unit 40 to scan a document according to the set conditions. Then the scanned data is stored into the storage unit 50 of the printer 1 or the HDD 86 of the host device 80, or printed through the printing unit 60 after undergoing the image processing. That is, the scanned data is processed in the scanning unit 40 into a predetermined data format to be sorted by the control unit 70. The processed data having the predetermined format is stored in the storage unit 50 or transmitted to the host device 80.

A size of the processed image data is shown in Table 1. Referring to Table 1, data size is different for each resolution. That is, the data sizes of each processed image data are 2.8 MB, 100 MB, 1.56 G and 6.2 G for low resolution (less than 100 dpi), medium resolution (less than 600 dpi), high resolution (from 600 to 2400 dpi) and super high resolution (2400 dpi or more), respectively. The data size is calculated based on A4 size and true color (24 bit).

TABLE 1

| Resolution | Size |
|---|---|
| Low resolution (less than 100 dpi) | 2.8M |
| Medium resolution (less than 600 dpi) | 100 MB |
| High resolution (less than 2400 dpi) | 1.56 G |
| Super high resolution (4800 dpi) | 6.2 GB |

As is described above, in a conventional image processing apparatus, where a plurality of sheets of documents are to be scanned, since images obtained by scanning the documents once should be stored in a storage media or printed out, a storage media with a large memory capacity is needed.

Furthermore, since the scanned image comprises a plurality of pixels and each pixel comprises color information obtained by complex mathematical operations, demand for a storage media with a large memory capacity is increasing.

### SUMMARY OF THE INVENTION

The present invention has been developed in order to solve the above drawbacks and/or other problems associated with the conventional arrangement. Therefore, aspects of the present invention provide an apparatus and a method of processing scanned images that is capable of reducing data size by locating and abstracting overlapped portions in the scanned images and separately storing the overlapped portions as overlay data from the non-overlapped portions.

In order to achieve these and/or other aspects and advantages of the present invention, a method of processing an image comprises producing the scanned images by scanning a plurality of manuscripts on which the scanned images are imprinted; checking for an overlapped portion in the scanned images; storing the overlapped portion as an overlay file; and storing non-overlapped portions in the scanned images as individual files.

In accordance with another aspect of the present invention, there is provided a method of processing scanned images, comprising producing the scanned images by scanning a plurality of manuscripts on which the scanned images are imprinted; checking for overlapped portions common in a plurality of the scanned images; storing the overlapped portions as overlay files; storing the scanned images without the overlapped portions as normal images; and storing non-overlapped portions in the scanned images, having one of the overlapped portions therein, as individual files.

According to this aspect, when a printing operation is requested, it is determined whether the scanned images requested to be printed include the overlay files, the overlay files and the associated individual files stored in the storing of the non-overlapped portions are combined when it is determined that the scanned images to be printed includes the overlay files, and then the combined images are printed. Where the scanned images requested to be printed do not include the overlay file, the normal images stored in the storing of the scanned images are printed. Further, the overlay files and the individual files have indices that notify each other that there are associated overlay files and individual files, and, when the printing is requested, the overlay files and the individual files are combined using the indices.

There is provided a scanned image processing apparatus according to another aspect of the present invention. The apparatus comprises a scanner to produce the scanned images by scanning a plurality of manuscripts on which the scanned images are imprinted; a storage unit to store the scanned images; and a control unit to locate overlapped portions in the scanned images, and to separately store the overlapped portions and non-overlapped portions as overlay files and individual files into the storage unit.

According to this aspect, the apparatus may further include an input unit to receive a print command from a user; and a printing engine unit to print the scanned images, wherein the apparatus is controlled such that when a printing operation is requested using the input unit, the control unit combines the overlay file and the individual file stored in the storage unit, and prints the combined files as the scanned image through the printing engine unit. Here, the control unit stores the overlay files and the individual files by attaching indices that notify each other of the existence of associated overlay files and/or individual files to the overlay files and the individual files. When printing is requested, the control unit controls such that the overlay files and the individual files are combined using the indices and then printing is performed.

There is an apparatus for processing scanned images, according to another aspect of the present invention. The apparatus comprises a scanner to produce the scanned images by scanning a plurality of manuscripts on which the scanned images are imprinted; a storage unit to store the scanned images; and a control unit to locate overlapped portions in the plurality of the scanned images, to store the overlapped portions in the scanned images as an overlay file and non-overlapped portions in the scanned images having the overlapped portions as individual files, and to store the scanned images without having any overlapped portions as normal images.

The apparatus may further include an input unit to allow a user to input a printing command, and a printing engine unit to print one of the scanned images, wherein, when printing is requested using the input unit, the control unit controls the apparatus such that the overlay file and the individual files are combined and printed through the printing engine unit. Here, when the object image requested to be printed does not include the overlapped portion, the control unit controls the apparatus such that the printing engine unit prints the object image by loading the normal image. The control unit stores the overlay file and the individual files by attaching indices, that notify each other of the existence of associated overlay files and individual files to each other, to the overlay file and the individual files. When printing is requested, the control unit controls the apparatus such that the overlay file and the individual files are combined using the indices and the combined files are printed.

There is provided an apparatus for processing scanned images, according to still another aspect of the present invention. The apparatus comprises a printer to perform printing and scanning to produce the scanned images by scanning a plurality of manuscripts on which the scanned images are imprinted; a host device including a storage unit to store the scanned images transmitted from the printer and a control unit to locate overlapped portions in the scanned images, and to store the overlapped portions in the scanned images as an overlay file and non-overlapped portions in the scanned images as individual files into the storage unit.

According to this aspect, the host device further includes an input unit to allow a user to input a printing command, wherein, when printing is requested using the input unit, the control unit controls the apparatus such that the overlay files and the individual files are combined in the host device and printed by the printer.

There is provided an apparatus for processing scanned images, according to still yet another aspect of the present invention. The apparatus comprising: a printer to perform printing and scanning so as to produce the scanned images by scanning a plurality of manuscripts on which the scanned images are imprinted; a host device including a storage unit to store the scanned images transmitted from the printer and a control unit so as to locate overlapped portions in the scanned images, and to store the overlapped portions in the scanned images as an overlay file, non-overlapped portions in the scanned images with the overlapped portion as individual files, and the scanned images without overlapped portions as normal images.

According to this aspect, the host device further includes an input unit allowing a user to input a printing command, wherein when printing is requested using the input unit, the control unit controls the whole apparatus such that the overlay file and the individual files are combined in the host device and printed by the printer. Here, when the images requested to be printed does not include the overlay file, the control unit controls the whole apparatus such that the normal images stored in the storage unit are printed by the printer. The control unit stores the overlay file and the individual files by attaching indices that notify existence of the overlay file and individual files to each other, to the overlay file and the individual files. When printing is requested, the control unit controls the apparatus such that the overlay file and the individual files are combined using the indices and the combined files are printed.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a conventional network printing machine;

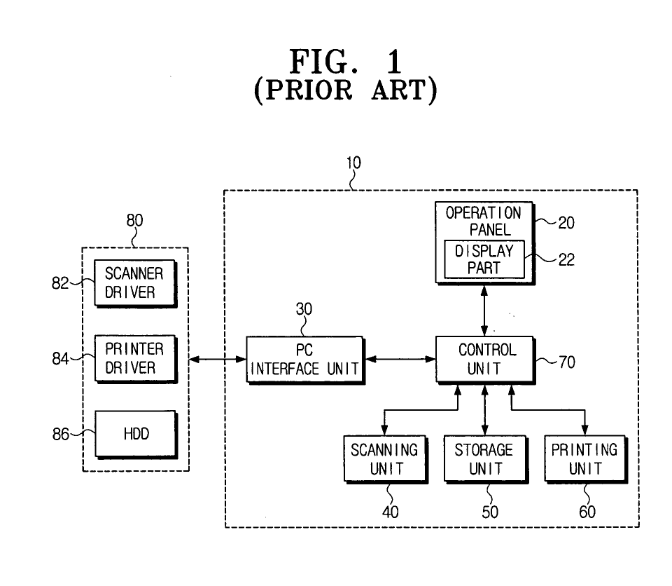

FIG. 2 is a block diagram illustrating an apparatus to process scanned images using a host device, according to an embodiment of the present invention;

FIG. 3 is a block diagram illustrating an apparatus to process scanned images using a printer, according to another embodiment of the present invention;

FIG. 4 is a flow chart illustrating a sequence of processing scanned images in a host device, according to an embodiment of the present invention;

FIG. 5 is a flow chart illustrating a sequence of printing scanned images using a host device;

FIG. 6 is a flow chart illustrating a method of processing and printing scanned images in a printer; and

FIGS. 7A-7C illustrate views to explain an overlay file.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

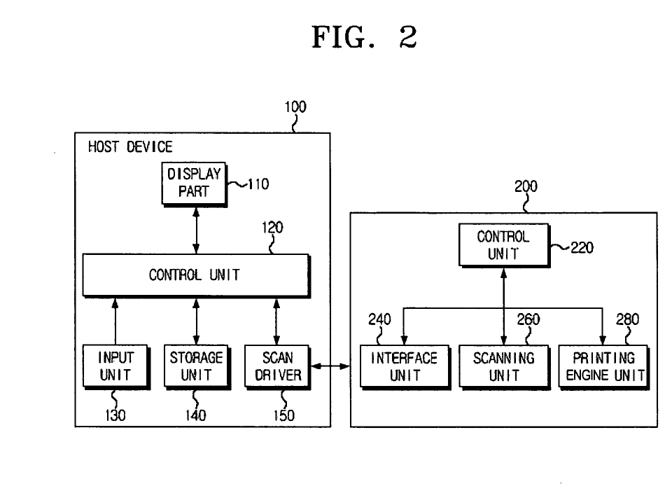

FIG. 2 is a block diagram illustrating an apparatus for processing scanned images using a host device. Referring to FIG. 2, a host device 100 is shown including a display unit 110, a control unit 120, an input unit 130, a storage unit 140 and a scan driver 150, which controls a printing machine 200 with a scanning operation to scan a document. The input unit 130 is built from a keyboard and/or a mouse (not shown). The display unit 110 displays a working status of peripheral units such as a scanning unit and a user interface (UI) to enable a user to set operational conditions of the scan driver 150.

The control unit 120 controls an overall operation of the host device 100. That is, if a scan mode is selected by a user using the input unit 130, the control unit 120 loads the scan driver 150 and displays a UI onto the display unit 110 to allow a user to set scanning conditions (degree of resolution, compression/no-compression). Then, the control unit 120 transmits information on the scanning conditions to the printing machine 200 so that the printing machine 200 scans a plurality of “documents or images” (hereinafter, referred to as a “manuscript”) according to the scanning conditions and produces scanned images.

Furthermore, the control unit 120 controls the host device so as to check for overlapped portions in the scanned images that are transmitted from the printing machine 200. The control unit 120 then produces an overlay file using the overlapped portions of the scanned images, and stores the overlay file into the storage unit 140. Meanwhile, non-overlapped portions of the scanned images are separately stored in the storage unit 140 as respective files.

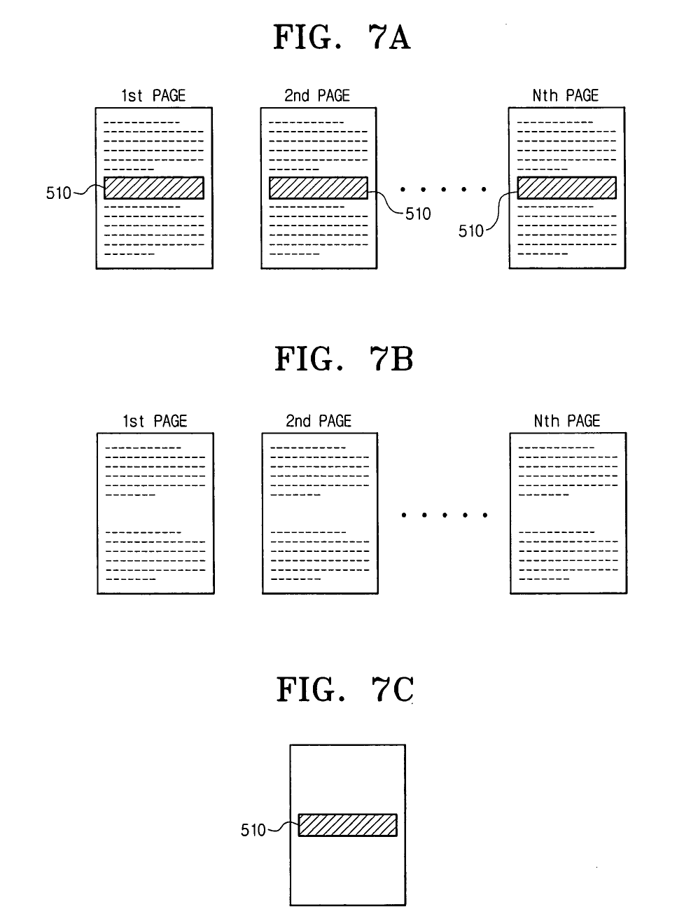

In greater detail, with reference to FIG. 7A, a plurality of scanned images (pages) that have an overlapped portion 510 are shown. The overlapped portions 510 of each image (page) are stored as an overlay file, as shown in FIG. 7C, in the storage unit 140. Further, since the overlapped portions 510 are separated from the original scanned images, there remains a non-overlapped portion for each image (page) as shown in FIG. 7B. The remaining non-overlapped portion for each image (page) is stored as an individual file.

The control unit 120 first locates an overlapped portion common in all the scanned images and then produces an overlay file using the overlapped portion, which is overlapped in all the scanned images. Alternatively, the control unit 120 may search for a particular overlapped portion, which is overlapped in only some scanned images, but not all of the scanned images. In this case, the control unit 120 abstractly removes the overlapped portions from each image in which it occurs and produces an overlay file of the overlapped portion. Images without overlapped portions are stored according to the conventional image processing method as normal files. However, in the images with at least one overlapped portion, non-overlapped portions of the scanned images are stored in respective individual files in units of images (pages). In accordance with an embodiment of the invention, a plurality of these overlay files may be produced.

The control unit 120 stores the individual files and the overlay files into the storage unit 140, attaching indices, which notify each other of an existence of associated overlay files and/or individual files, to the overlay files and individual files. Accordingly, when a printing mode is selected using the input unit, the control unit 120 controls the printing machine 200 such that the overlay files and the individual files are loaded and combined so as to produce original complete images, and the combined images are printed out.

The printing machine 200 includes a control unit 220, an interface unit 240, a scanning unit 260 and a printing engine unit 280. The control unit 220 controls the overall operation of the printing machine 200 according to a control program stored in an internal read only memory (ROM). The interface unit 240 is provided to connect the printing machine 200 to external devices (i.e., the host device 100), and provides the communication interface between the printing machine 200 and the host device 100. That is, the printing machine 200 receives print object data transmitted from the host device 100, and transmits scanned images produced by scanning unit 260 to the host device 100 by way of the interface unit 240.

When a scanning command transmitted from the host device 100 is received in the printing machine 200, the control unit controls the scanning unit 260 to scan a plurality of manuscripts, to produce scanned images, and to transmit the scanned images to the host device 100. Meanwhile, if print object data is transmitted from the host device 100 and received in the printing machine 200, the control unit 220 controls the printing machine 200 to print the print object data through the printing engine 280.

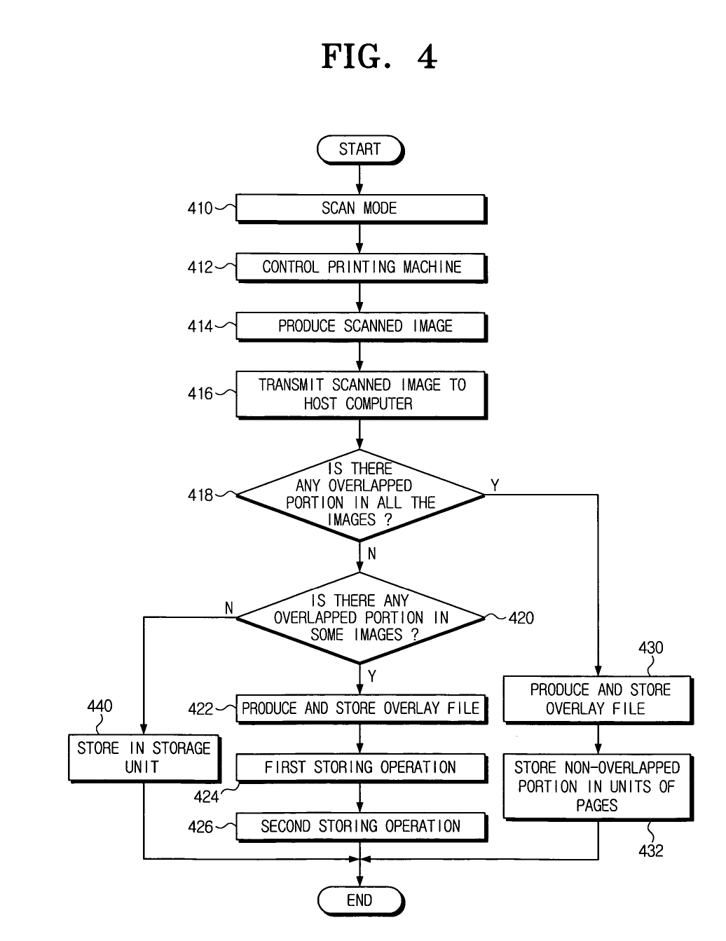

Hereinafter, a method of processing scanned images using the host device, according to an embodiment of the invention, will be described below. FIG. 4 is a flow chart illustrating a sequence of a processing of scanned images using the host device. As shown in FIG. 4, if a scan mode is selected using the input unit 130 of the host device 100 to perform scanning (410), the control unit 120 drives the scan driver 150 to transmit a scan command to the interface unit 240 so that the printing machine 200 is instructed to scan a manuscript (412).

If the scan command is received in the printing machine 200 through the interface unit 240, the control unit 220 of the printing machine 200 controls the scanning unit 260 to scan the manuscript to produce a plurality of scanned images (414). If the scanned images produced in operation 414 are transmitted to the host device 100 (416), the control unit 120 determines whether the scanned images include an overlapped portion (418). If the control unit 120 determines that there is no overlapped portion common in all the scanned images, whether there are any overlapped portions common in only some of the images, as opposed to all of the images, is checked (420).

In operation 418, the overlapped portion is stored as an overlay file into the storage unit 140 (430), and the non-overlapped portions of the original scanned images are separately stored as respective individual files in units of images (pages) into the storage unit 140 (432). Further, in operation 420, if it is found that at least one image has an overlapped portion with another image, the overlapped portion is stored as an overlay file into the storage unit (422).

The scanned images without overlapped portions are stored as normal image files in units of images (424: the first image storing operation). Meanwhile, the overlapped portion is stored as an overlay file into the storage unit 140 and non-overlapped portions in the scanned images having overlapped portions are separately stored as individual files (426: the second image storing operation).

In operation 420, images without overlapped portions are stored into the storage unit 140 in units of images, and image processing sequences for such images are completed (440).

When storing the overlay files and the individual files into the storage unit 140, indices are attached to the overlay files and/or the individual files to notify of an existence of associated overlay files. The indices are used in printing the scanned images. That is, the overlay files and the individual files in association with the scanned images to be printed are first retrieved using the indices, and the overlay files, if there are any, as well as the individual files are loaded together and combined with each other. Accordingly, the method, according to aspects of the present invention, provides an advantage of reducing a memory capacity taken up by the scanned images.

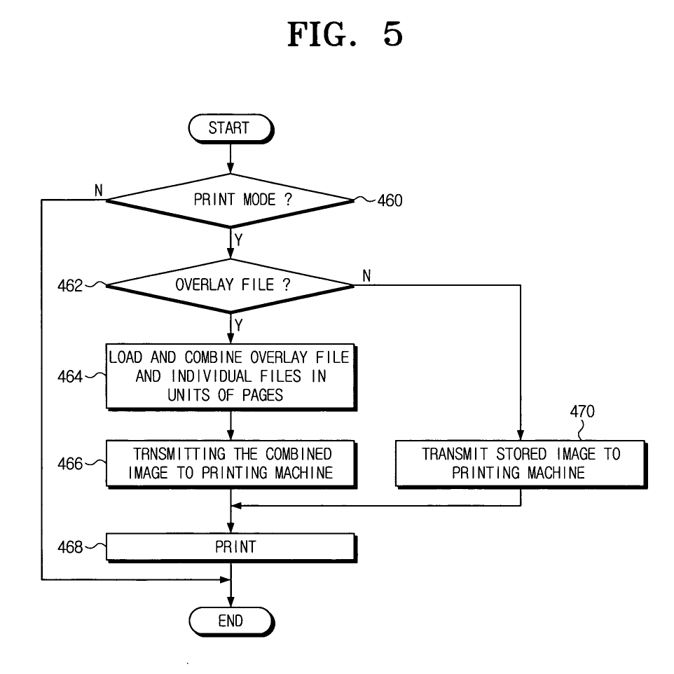

Hereinafter, a sequence to print out the stored scanned images using the overlay files and the individual files stored in the storage unit 140 will be described below. FIG. 5 is a flow chart illustrating the sequence of printing out the scanned images processed according to an aspect of the scanned image processing method of this invention. If a printing mode is selected in the host device using the input unit 130 (460), the control unit 120 searches the overlay files and the individual files stored in the storage unit 140 to check for any overlay files associated with the document to be printed (462). Here, if an overlay file associated with the document to be printed is detected, the control unit 120 loads the overlay file and the individual files in association with the document to be printed from the storage unit 140, and combines the overlay file and the individual files to produce complete images (464). The produced images are then transmitted to the printing machine 200 and printed out through the printing engine unit 280 (468).

Alternately, in operation 462, where an overlay file in association with the images to be printed out is undetected, the control unit 120 loads the images from the storage unit 140 and transmits the images to the printing machine 200 so as to be printed out (470).

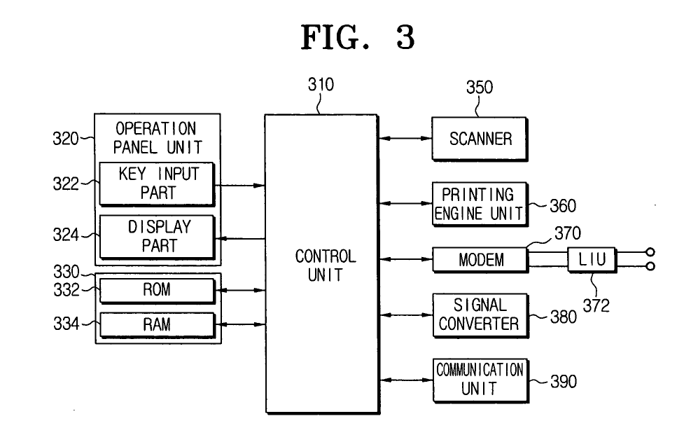

FIG. 3 is a block diagram illustrating an apparatus to process scanned images, according to another embodiment of the present invention. Referring to FIG. 3, a printing machine with a scanning ability includes an operation panel unit 320, a storage unit 330, a scanner to scan an object document, a printing engine unit 360 to print the object document, a modem 370 built from a first communication module to support a facsimile operation that transmits and receives facsimile data, a line interface unit (LIU) 372, a signal converter 380, a communication unit 390 built from a second communication module to support an e-mailing operation that transmits and receives e-mails and a control unit 310.

The operation panel unit 320 includes a key input part 322 with mode selection keys (not shown) to allow a user to select a scan mode and a print mode, and a display part 324 to display a working status of the printer and a GUI through which a user sets the scanner driver and the printer driver. The storage unit 330 comprises a read only memory (ROM) 332 and a random access memory (RAM) 334. The ROM 332 is a nonvolatile memory device and stores various control programs needed to implement various operations provided by the printer, a firmware to convert scanned analog data produced by the scanner 350 to digital data, and a data transmission protocol. The RAM 334 is a volatile memory and stores various data produced during the working of the printing machine. That is, the RAM 334 temporarily stores the scanned data produced by the scanner 350 and facsimile data received from external communication devices through the modem 370.

The scanner 350 scans an object document under the control of the control unit 310 to produce scanned image data. The image data produced by the scanner 350 is converted to digital data and then is temporarily stored into the RAM 334 or printed out using the printing engine unit 360. Further, the digital data may be transmitted to external devices through the modem 370 or the communication unit 390.

The printing engine unit 360 prints out the print object data under the control of the control unit 310. The print object data is scanned image data produced by the scanner 350, facsimile data transmitted from the external devices through the modem 370, mail data transmitted from the external devices through the communication unit 390, or a combination thereof.

The modem 370 converts facsimile data, which is to be transmitted to an external facsimile (not shown) machine, into analog signals under the control of the control unit 310 and demodulates analog facsimile data transmitted from an external facsimile through the LIU 372 to facsimile data and then transmits the demodulated data to the control unit 310. The signal converter 380 converts the digital data into e-mail data based on an e-mail transmission standard. The communication unit 390 transmits the e-mail converted by the signal converter 380 into external mail servers (not shown) and receives e-mails transmitted from external mail servers. The e-mails received through the communication unit 390 are stored into the RAM 334 or printed out by the printing engine unit 360. The communication unit 390 transmits and receives e-mails using a local area network (LAN) connection method or a public switched telephone network (PSTN) connection method.

The control unit 310 controls overall operations of the printing machine according to the control program stored in the ROM 342. Particularly, when the scanning operation is selected using the key input unit 322, the control unit 310 controls the scanner 350 to scan a plurality of manuscripts. Further, the control unit 310 controls the printing machine to locate overlapped portions in the scanned images, and to produce an overlay file using the overlapped portions and individual files using the non-overlapped portions. The control unit 310 also stores the overlay file and the individual files into the storage unit 330.

At this time, scanned images without overlapped portions may be stored using a conventional method, but scanned images with overlapped portions are separated into overlapped portions and non-overlapped portions that are stored as overlay files and individual files, respectively. Here, according to an embodiment of the invention, there may be a plurality of overlay files. Furthermore, the control unit 310 makes indices notifying each other of an existence of overlay files and stores the indices with the overlay files and the individual files together into the storage units 330. Accordingly, when the print mode is selected using the key input unit 322, the control unit 310 controls load and combines the overlay files and the individual files stored in the storage unit 330 and controls the printing engine unit 360 to print out the combined file.

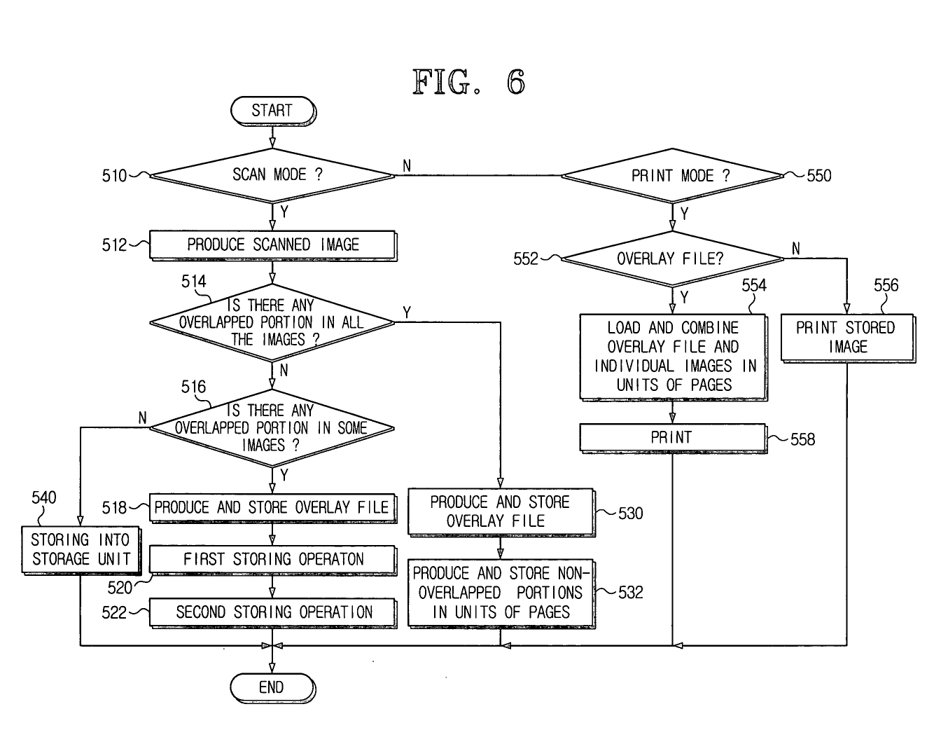

Hereinafter, a method of processing scanned images using a printer will be described. FIG. 6 is a flow chart illustrating the method of processing scanned images using a printing machine. As shown in FIG. 6, when the scan mode is selected using the key input units 322 (510), the control unit 310 controls the scanner 350 to scan a plurality of manuscripts so as to produce a plurality of scanned images (512).

The control unit 310 checks whether there is an overlapped portion over the plurality of scanned images produced in operation 512 (514). In operation 514, whether all of the scanned images have a common overlapped portion is checked. Then, if there is no common overlapped portion in all of the scanned images, the control unit 310 checks whether there is an overlapped portion common in at least one image (516).

In operation 514, the control unit 310 produces an overlay file with the overlapped portion common in all the scanned images and stores the overlay file into the storage unit 330 (530), and produces individual files with the non-overlapped portion in each image and stores the individual files into the storage unit 330 (532). In operation 516, the control unit 310 produces a plurality of overlay files with overlapped portions common in one or more scanned images out of all the scanned images and stores the overlay files into the storage unit 330 (518). Then, scanned images without overlapped portions with other images are stored as normal files (520: first storing operation), and scanned images having any overlapped portions with other images are separated into overlapped portions and non-overlapped portions and then stored as overlay files and individual files, respectively (522: second storing operation). In operation 516, if the scanned images do not have any overlapped portions, the scanned images are stored into the storage unit 330 and the image processing ends (540).

When storing the overlay files and individual files, indices that notify each other of an existence of the overlay files, are made and stored along the overlay files or the individual files to notify each other of an existence of the overlay files. The indices are used when printing the scanned images to check whether there are the overlay files associated with a print object image to be printed. If it is determined that there are overlay files, the overlay files and the individual files are loaded together from the storage unit 330 and combined with each other to produce original scanned images. Accordingly, since overlapped portions in scanned images are managed as a shared file, data size of the scanned images can be reduced.

Hereinafter, the sequence of printing the scanned images by combining the overlay files and individual files is described. When the print mode is selected using the key input unit 322 (550), the control unit searches the overlay files and the individual files stored in the storage unit 330 to check for the overlay files associated with the print object image to be printed (552). In operation 520, it is determined if there is any overlay file, and the overlay files and the individual files in association with the print object image are loaded together, and combined to produce the original complete image to be printed (554). The combined image files are then printed through the printing engine unit 360 (558).

In operation 552, where the print object image to be printed does not have an overlay file, the print object image is loaded from the storage unit 330 and printed through the printing engine unit 360 (556). By repeatedly performing operations 552 to 558, the scanned images having one or more overlapped portions in one or more scanned images may be printed.

When there is an overlapped portion common in all the scanned images, memory capacity may be most saved. However, the memory capacity is also reduced even where overlapped portions are common in less than all of the images, and the overlapped portions are managed as a plurality of overlay files.

The apparatus and method of processing scanned images, according to aspects of the present invention, provides at least the following advantages. They may provide an ability to save memory capacity due to reduced data size by managing and storing overlapped portions in a plurality of scanned images as one or more overlay file compared to conventional method in which all the scan images are separately managed and stored in units of images. Accordingly, the apparatus and method of this invention may be effectively used in a personal digital assistant (PDA) with small memory capacity.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of processing scanned images, comprising:
producing the scanned images by scanning a plurality of manuscripts on which the scanned images are imprinted;
checking for an overlapped portion in the scanned images;
storing the overlapped portion as an overlay file; and
storing non-overlapped portions in the scanned images as individual files.

2. The method of claim 1, further comprising combining the overlay file and the individual files when a printing of the scanned images is requested.

3. The method of claim 2, wherein the overlay file and the individual files are stored in indices, which notify each other of an existence of the overlay file and the individual files.

4. The method according to claim 3, wherein, when the printing is requested, the overlay file and the individual files are retrieved and combined using the indices as guides.

5. A method of processing scanned images, comprising:
producing the scanned images by scanning a plurality of manuscripts on which the scanned images are imprinted;
checking for overlapped portions common in a plurality of the scanned images;
storing the overlapped portions as overlay files;
storing the scanned images without the overlapped portions as normal images; and
storing non-overlapped portions in the scanned images, having one of the overlapped portions therein, as individual files.

6. The method according to claim 5, wherein, when a printing operation is requested, the method further comprises:
determining whether the scanned images requested to be printed include the overlay files;
combining the overlay files and the associated individual files stored in the storing of the non-overlapped portions when the scanned images determined to be printed include the overlay files; and
printing the combined files.

7. The method of claim 6, wherein, where the scanned images requested to be printed do not include the overlay files, the method further comprises printing the normal stored file.

8. The method of claim 7, wherein the overlay files and the individual files comprise indices, which notify each other of an existence of associated overlay files and individual files.

9. The method of claim 8, wherein, when the printing operation is requested, the overlay files and the individual files are combined using the indices.

10. An apparatus to process scanned images, comprising:
a scanner to produce the scanned images by scanning a plurality of manuscripts on which the scanned images are imprinted;
a storage unit to store the scanned images; and
a control unit to locate overlapped portions in the scanned images, and to separately store the overlapped portions and non-overlapped portions as overlay files and individual files into the storage unit.

11. The apparatus of claim 10, further comprising:
an input unit to receive a print command from a user; and
a printing engine unit to print the scanned images, wherein the apparatus is controlled such that when a printing operation is requested using the input unit, the control unit combines the overlay files and the individual files stored in the storage unit, and prints the combined files as the scanned image through the printing engine unit.

12. The apparatus of claim 11, wherein the control unit stores the overlay files and the individual files by attaching indices, which notify each other of an existence of overlay files and/or individual files, to the overlay files and the individual files.

13. The apparatus of claim 12, wherein, when printing is requested, the control unit controls the overlay files and the individual files to be combined using the indices and then printing is performed.

14. An apparatus to process scanned images, comprising:
a scanner to produce the scanned images by scanning a plurality of manuscripts on which the scanned images are imprinted;
a storage unit to store the scanned images; and
a control unit to locate overlapped portions in the plurality of the scanned images, to store the overlapped portions in the scanned images as an overlay file and non-overlapped portions in the scanned images having the overlapped portions as individual files, and to store the scanned images without having any overlapped portions as normal images.

15. The apparatus of claim 14, further comprising:
an input unit to allow a user to input a printing command; and
a printing engine unit to print one of the scanned images, wherein, when printing is requested using the input unit, the control unit controls the apparatus such that the overlay file and the individual files are combined and printed through the printing engine unit.

16. The apparatus of claim 15, wherein, when the scanned image does not include the overlapped portion, the control unit controls the apparatus such that the printing engine unit prints the scanned image by loading the normal image.

17. The apparatus of claim 15, wherein the control unit stores the overlay file and the individual files by attaching indices, which notify each other of an existence of associated overlay files and individual files, to the overlay file and the individual files.

18. The apparatus of claim 17, wherein, when a printing operation is requested, the control unit controls the apparatus such that the overlay file and the individual files are combined using the indices and the combined files are printed.

19. An apparatus to process scanned images, comprising:
a printer to perform printing and scanning to produce the scanned images by scanning a plurality of manuscripts on which the scanned images are imprinted;
a host device including a storage unit to store the scanned images transmitted from the printer and a control unit to locate overlapped portions in the scanned images, and to store the overlapped portions in the scanned images as an overlay file and non-overlapped portions in the scanned images as individual files into the storage unit.

20. The apparatus of claim 19, wherein the host device further comprises an input unit allowing a user to input a printing command, such that, when printing is requested using the input unit, the control unit controls the whole apparatus such that the overlay file and the individual files are combined in the host device and printed by the printer.

21. An apparatus to process scanned images, comprising:
a printer to perform printing and scanning so as to produce the scanned images by scanning a plurality of manuscripts on which the scanned images are imprinted;
a host device including a storage unit to store the scanned images transmitted from the printer and a control unit so as to locate overlapped portions in the scanned images, and to store the overlapped portions in the scanned images as an overlay file, non-overlapped portions in the scanned images with the overlapped portion as individual files, and the scanned images without overlapped portions as normal images.

22. The apparatus of claim 21, wherein the host device further comprises an input unit to allow a user to input a printing command, such that when printing is requested using the input unit, the control unit controls the apparatus such that the overlay file and the individual files are combined in the host device and printed by the printer.

23. The apparatus of claim 22, wherein, when the images requested to be printed do not include the overlay file, the control unit controls the apparatus such that the normal images stored in the storage unit are printed by the printer.

24. The apparatus of claim 22, wherein the control unit stores the overlay file and the individual files by attaching indices, which notify each other of an existence of the overlay file and individual files, to the overlay file and the individual files.

25. The apparatus of claim 24. wherein, when a printing operation is requested, the control unit controls the apparatus such that the overlay file and the individual files are combined using the indices and the combined files are printed.

26. A method of reducing a required memory capacity of an image scanning apparatus operating on a document, comprising:
determining whether all scanned images of the document contain an overlapping portion;
if all the scanned images of the document contain the overlapping portion, storing the overlapping portion as an overlay file and storing non-overlapping portions as individual files;
determining whether some of the scanned images contain an overlapping portion;
if some of the scanned images of the document contain the overlapping portion, storing the scanned images without the overlapping portion as image files, storing the overlapping portion as an overlay file, and storing non-overlapping portions as individual files; and
if none of the scanned images contain an overlapping portion, storing the scanned images as image files.

27. The method according to claim 26, wherein, when the scanned images are to be printed, the method further comprises:
determining whether the overlay file exists;
if no overlay file exists, printing the image files;
if the overlay file exists, combining the overlay file with the individual files and printing the combined files.

28. A method of reducing a required memory capacity of an image scanning apparatus operating on a document, comprising:
determining whether all scanned images of the document contain an overlapping portion;
if all the scanned images of the document contain the overlapping portion, storing the overlapping portion as a shared file and storing non-overlapping portions as individual files;
determining whether some of the scanned images contain an overlapping portion;
if some of the scanned images of the document contain the overlapping portion, storing the scanned images without the overlapping portion as image files, storing the overlapping portion as a shared file, and storing non-overlapping portions as individual files; and
if none of the scanned images contain an overlapping portion, storing the scanned images as image files.

29. The method according to claim 28, wherein, when the scanned images are to be printed, the method further comprises:
determining whether the shared file exists;
if no shared file exists, printing the image files; and
if the shared file exists, combining the shared file with the individual files and printing the combined files.
